(19) United States
(12) Patent Application Publication
(10) Pub. No.: US 2005/0252020 A1
(43) Pub. Date: Nov. 17, 2005

(54) Tape measure using flexible tape having extended width

(76) Inventors: James M. Critelli, Fuquay-Varina, NC (US); Edgar T. Gilliam JR., Franklinton, NC (US); Christopher T. Cluff, Holly Springs, NC (US); William C. Blackman, Raleigh, NC (US); John B. Moody, Raleigh, NC (US); William E. Bass, Apex, NC (US); Adam L. Weeks, Raleigh, NC (US); Stephen E. Donelson, Raleigh, NC (US)

Correspondence Address: COATS & BENNETT, PLLC, P O BOX 5, RALEIGH, NC, 27602, US

(21) Appl. No.: 10/844,840

(22) Filed: May 13, 2004

(51) Int. Cl. G01B 3/10

(52) U.S. Cl. 33/755

(57) ABSTRACT

A tape measure comprises a main case; a flexible non-metallic tape selectively deployable from the case; the tape comprising a matrix of a plurality of longitudinally disposed reinforcing strands and a polymer; at least a first length indicating measuring scale printed on the tape and visible to a user when the tape is deployed; the tape having a generally flat cross-sectional profile when deployed from the main case and having a width in the range of approximately ⅝ inch to approximately one inch. The tape measure may advantageously further comprise a see-through outer coating, the first length indicating measuring scale visible through the outer coating; and/or a second length indicating measuring scale printed on the tape and visible to a user when the tape is deployed. The plurality of reinforcing strands may advantageously comprise at least thirty strands of glass fiber material. A corresponding method is also disclosed.

### BACKGROUND OF THE INVENTION

The present invention is directed generally to tape measures that use non-metallic flexible tapes, and more particularly to a tape measure that uses a non-metallic flexible tape having extended tape width and optionally greater strength.

Tape measures (or “tape rules”) that use flexible non-metallic tapes have been known for some time. One example of a tape measure that uses a flexible non-metallic tape is marketed under the name Hi-Viz Linear Reel 1706, available from Cooper Industries of Houston, Tex. For such tape measures, it is typical for the tapes to be quite long, such as fifty to three hundred feet in length. Due to this long length, such tapes are typically designed to be manually rewound rather than having spring-based power-return rewind mechanisms. The long lengths of such tapes allows such tapes to be used to measure relatively long distances, such as might be required on construction sites to measure foundations or for site surveys. When long lengths of a measuring tape are played out, there is increased chance that the tape may somehow catch or otherwise snag on some object. When this happens, the tape may be subjected to significant tension loadings, sometimes leading to tape breakage. In addition, the absolute amount of measurement error introduced by tape stretch increases as longer distances are measured.

While the above issues relate to the material properties of the tape, other considerations must also be taken into account when designing long length tapes. For example, it may be desirable to measure different distances using different scales; obviously, two different measuring tapes may be used for such purpose, but this is less than desirable in most situations. Further, the typical size of printing on the conventional tape blades sometimes makes the markings difficult to read, leading to measurement errors.

While a number of tape measures having flexible non-metallic tapes have been proposed, there remains a need for alternative tape measure designs.

### SUMMARY

The present invention is directed to a tape measure that uses a flexible non-metallic tape. In one embodiment, the tape measure comprises a main case; a flexible non-metallic tape selectively deployable from the case; the tape comprising a plurality of generally longitudinally disposed reinforcing strands in a polymer matrix; at least a first length indicating measuring scale printed on the tape and visible to a user when the tape is deployed; the tape having a generally flat cross-sectional profile when deployed from the main case and having a width in the range of approximately ⅝ inch to approximately one inch. The tape may further comprise an outer coating generally surrounding the reinforcing strands in the polymer matrix, advantageously with the first length indicating measuring scale visible to a user through the outer coating when the tape is deployed. The tape may further comprise a second length indicating measuring scale printed on the tape and visible to a user when the tape is deployed. The plurality of reinforcing strands may comprise at least thirty strands of glass fiber material; the width of the tape may advantageously be approximately ⅝ inch; and the tape measure may further comprise a hook attached to a free end of the tape. The tape may have break strength of at least 250 pounds and/or the tape may advantageously stretch by not more than 0.12% over the load range four-and-one-half to twenty pounds applied tension.

In another embodiment, a method of forming a tape measure comprises forming a flexible non-metallic ribbonous core by feeding a plurality of reinforcing strands through a die while supplying a polymer to the die, the core having a width of approximately ⅝ inch to approximately 1 inch and a generally flat cross-sectional profile; thereafter, printing at least a first length indicating measuring scale on the core; thereafter, joining the core to a main case so as to allow the core to be selectively deployable from the case with the first length indicating measuring scale being visible to a user when the tape is deployed. The method may further comprise overcoating the core having the first scale thereon with a coating prior to the joining. The method may further comprise printing a second length indicating measuring scale on the core after the forming and before the overcoating. The forming a ribbonous core may comprise forming a ribbonous core by feeding at least thirty reinforcing strands of glass fiber through the die while supplying the polymer to the die. The width of the core may be approximately ⅝ inch and/or the core with the coating thereon may have a tensile break strength of at least 250 pounds.

### BRIEF DESCRIPTION OF THE DRAWINGS

FIG. 1 shows a tape measure constructed in accordance with one embodiment of the present invention.

FIG. 2 shows a portion of the measuring tape in accordance with one embodiment of the present invention.

FIG. 3 shows a cross-section of the measuring tape of FIG. 2.

FIG. 4 shows a schematic representation of a process used to manufacture the tape measure of FIG. 1 according to one embodiment of the present invention.

### DETAILED DESCRIPTION OF THE INVENTION

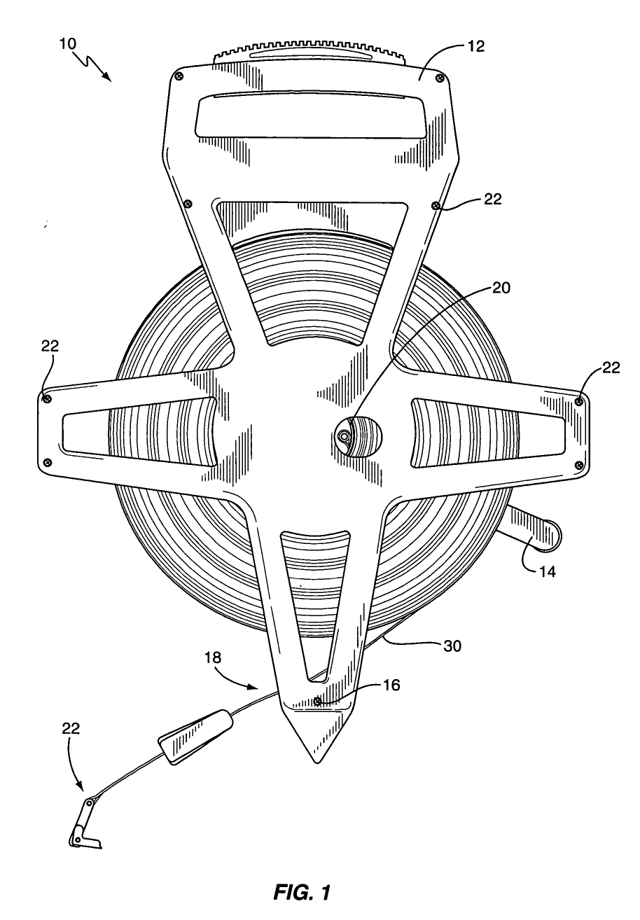

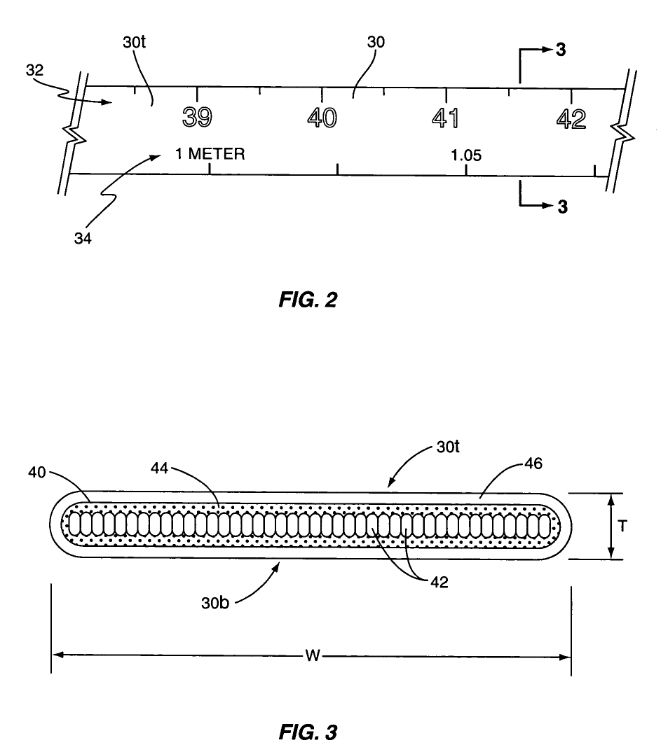

As illustrated in FIG. 1, a tape measure, generally designated 10, is shown constructed according to the present invention. The tape measure 10 includes a housing 12, a winding hub 20, and a measuring tape 30 coiled partly thereon. The shell of the housing is typically formed of two half-shells joined together by suitable means such as screws 16 (or rivets) and typically has a crank 14 accessible from one side. The crank 14 is disposed toward or at the center of one side of the housing 12 and connects to the winding hub 20. The crank 14 may be of a rigid one-piece construction, or may advantageously be of a folding type well known in the art. The winding hub 20 is rotatably supported in the housing 12 and provides a rotatable support means for supporting and storing the tape 30 when wholly or partially rewound. The tape 30 has one end connected to the winding hub 20 and the other end extending out the tape portal opening 18 in the housing 12. The free end of the tape 30 may have a hook 22 or other securing means attached thereto in a conventional fashion. Suitable reinforcing means, such as rubber strips, may be added to the tape 30 proximate the hook 22 so as to reduce damage to the tape 30.

The general description of the tape measure 10 given immediately above is consonant with conventional tape measures well known in the art. Additional details may be found in U.S. Pat. No. 6,698,679, entitled “Tape Measure with Sliding Tape Grip Element,” which is incorporated herein by reference. As such, further details of the construction of tape measure 10 have been generally omitted for brevity, except when helpful to understand the present invention. It should be understood that the tape measure housing 12 and the like may take other forms known in the art without departing from the present invention. Just by way of example, the housing 12 may of a fully enclosing type, rather than the partially open type shown in FIG. 1.

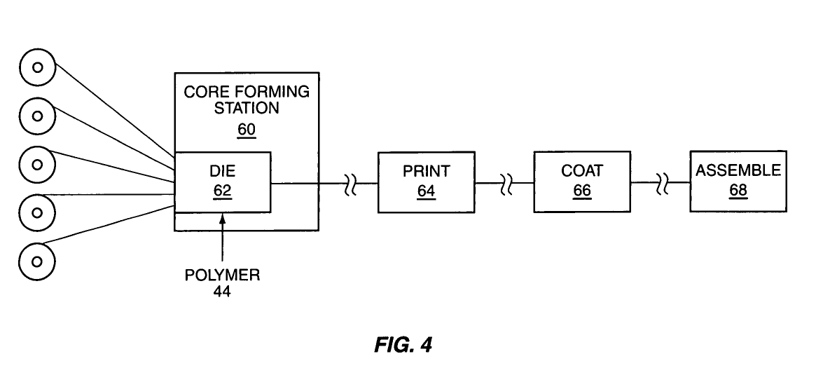

The measuring tape 30 of the present invention is different from those known in the prior art. The measuring tape 30 is a non-metallic flexible ribbon of material with a top side 30t, bottom side 30b, a thickness T, and a width W. As shown in FIG. 3, the measuring tape 30 may advantageously have a multi-layer construction, with a ribbonous core 40 formed from a plurality of reinforcing strands 42 in a polymer matrix 44. Is should be noted that the term matrix as used herein with reference to the polymer matrix 44 does not require a regularly ordered arrangement of the polymer material, but is instead used in the sense of a surrounding substance within which something else is contained or a binding substance. The core 40 may have the length marking indicia 32,34 printed thereon, with an optional outer coating 46 of a see-through polymer. Alternatively, the length marking indicia may be printed on the outer coating 46, but this is believed less advantageous.

Numerous tape measures have been made with measuring tapes having widths of ½ inch and substantially flat cross-sectional shapes when deployed. For the present invention, the width W is approximately ⅝ of an inch to approximately one inch and the cross-sectional shape is substantially flat when deployed. Thus, the tape 30 of the present invention is wider than non-metallic flexible tapes in the prior art. The additional width of the measuring tape 30 allows the core 40 of the measuring tape 30 to be formed with more reinforcing strands 42 than in the prior art. The additional reinforcing strands 42 reinforce the tape 30, providing additional resistance to both breakage and undesirable stretching. For example, the tape 30 with a width W of ⅝ inch using thirty-two reinforcing strands 42 of the type elsewhere described may advantageously have a tensile strength of at least two-hundred fifty pounds and stretch by not more than 0.12% over a load range of four-and-one-half to twenty pounds applied tension. Such results are believed best achieved when the reinforcing strands 42 are disposed in bunched arrangement so that adjacent reinforcing strands 42 are not separated by intervening material of the polymer matrix 44.

Further, the additional width of the tape 30 allows for greater flexibility in marking of the measuring tape 30. For example, the additional space on the upper surface 30t of the tape 30 allows for printing in a larger font size. Alternatively, or in addition thereto, the additional space allows for the inclusion of an alternative length indicating scale 34, so that the tape 30 has both a primary scale 32 and an independent secondary scale 34 indicted thereon with measurement units different than those of the primary measurement scale 32. The secondary scale 34 may be printed in the same orientation as the primary scale 32, or may be in a different orientation, as is desired. For example, the primary length indicating scale 32 may be inches with black indicia oriented to read from one direction and the secondary length indicating scale 34 may be meters with red indicia oriented to read from the opposite direction.

The reinforcing strands 42 may be continuous filament glass fiber strands, such as those offered under part number ECG-75-1/0 (0.7Z tpi) from Owens Corning Fiberglass Co. of Toledo, Ohio. For a ⅝″ wide measuring tape 30, there may be at least thirty of such reinforcing strands 42, and advantageously forty to fifty of such reinforcing strands 42. The polymer matrix 44 surrounding the reinforcing strands may be PVC or other suitable polymer. The outer see-through layer 46 may be a polymer referred to in the art as clearcoat. The typical tape 30 may be fifty to three hundred feet in length, advantageously at least one hundred feet.

In one embodiment, the measuring tape 30 may be made by feeding the reinforcing strands 42 through a suitable extrusion die 62 with the material of the polymer matrix 44 (e.g., PVC) added to form the ribbonous core 40 at a core forming station 60. It should be noted that the reinforcing strands 42 may advantageously be arranged in a tightly-packed side-by-side arrangement, with the reinforcing strands 42 running parallel to the longitudinal axis of the tape 30. Alternatively, the reinforcing strands 42 may be woven together before the polymer matrix 44 is added. Either way the reinforcing strands 42 are considered to be disposed generally along the longitudinal axis of the tape 30. After allowing the core 40 to cool, the core 40 may be wound on a spool. The spool may be then taken to a printing station 64 where the primary length indicating scale 32, and optionally the secondary length indicating scale 34, are added. The printed core 40 may then be processed at a coating station 66 where the optional “clearcoat” outer coating 66 is added, such as by using conventional coating rollers. The resulting product may then be wound onto the winding hub 20 and the remainder of the tape measure assembled in a conventional fashion at an assembly station 68. Of course, the housing 12 and winding hub 30 should be sized to accommodate the wider than normal measuring tape 30.

In some embodiments, the reinforcing strands 42 are separated from each other by material of the polymer matrix 44. However, in other embodiments, the reinforcing strands 42 are tightly bunched in a side-by-side arrangement. This later arrangement is believed more resistant to longitudinal splitting due to very slight overlapping of the reinforcing strands 42 and/or the lack of spaces between the reinforcing strands 42 filled by relatively weaker material of the polymer matrix 44.

It should be understood that the tape measures 10 of the present invention may also include other features, such as shock-absorbing bumpers proximate the opening, various locking mechanisms, hook reinforcing plates, gear based winding mechanisms, and like, all of which are known in the art.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

1. A tape measure, comprising:
a main case;
a flexible non-metallic tape selectively deployable from said case; said tape comprising a plurality of generally longitudinally disposed reinforcing strands in a polymer matrix;
at least a first length indicating measuring scale printed on said tape and visible to a user when said tape is deployed;
said tape having a generally flat cross-sectional profile when deployed from said main case and having a width in the range of approximately ⅝ inch to approximately one inch.

2. The tape measure of claim 1 wherein said tape further comprises an outer coating generally surrounding said reinforcing strands in said polymer matrix.

3. The tape measure of claim 2 wherein said first length indicating measuring scale is visible to a user through said outer coating when said tape is deployed.

4. The tape measure of claim 1 further comprising a second length indicating measuring scale printed on said tape and visible to a user when said tape is deployed.

5. The tape measure of claim 1 wherein said plurality of reinforcing strands comprises at least forty strands of glass fiber material.

6. The tape measure of claim 1 wherein said width of said tape is approximately ⅝ inch.

7. The tape measure of claim 1 further comprising a hook attached to a free end of said tape.

8. The tape measure of claim 1 wherein said tape has a break strength of at least 250 pounds.

9. The tape measure of claim 1 wherein said tape stretches by not more than 0.12% over a range of four-and-one-half to twenty pounds applied tension.

10. The tape measure of claim 1:
further comprising a second length indicating measuring scale printed on said tape and visible to a user when said tape is deployed;
wherein said tape further comprises an outer coating generally surrounding said reinforcing strands in said polymer matrix, said first length indicating measuring scale and said second length indicating measuring scale visible through said outer coating;
wherein said plurality of reinforcing strands comprises at least thirty strands of glass fiber material; and
wherein said width of said tape is approximately ⅝ inch; and
wherein said tape has a break strength of at least 250 pounds.

11. A method of forming a tape measure, comprising:
forming a flexible non-metallic ribbonous core by feeding a plurality of reinforcing strands through a die while supplying a polymer to said die, said core having a width of approximately ⅝ inch to approximately 1 inch and a generally flat cross-sectional profile;
thereafter, printing at least a first length indicating measuring scale on said core;
thereafter, joining said core to a main case so as to allow said core to be selectively deployable from said case with said first length indicating measuring scale being visible to a user when said tape is deployed.

12. The method of claim 11 further comprising overcoating said core having said first scale thereon with a coating prior to said joining.

13. The method of claim 12 further comprising printing a second length indicating measuring scale on said core after said forming and before said overcoating.

14. The method of claim 11 wherein said forming a ribbonous core comprises forming a ribbonous core by feeding at least thirty reinforcing strands of glass fiber through said die while supplying said polymer to said die.

15. The method of claim 11 wherein said width of said core is approximately ⅝ inch.

16. The method of claim 12 wherein said core with said coating thereon has a tensile break strength of at least 250 pounds.

17. The method of claim 11:
further comprising printing a second length indicating measuring scale on said core after said forming;
further comprising overcoating said core having said first and second scales thereon with a coating prior to said joining;
wherein said forming a ribbonous core comprises forming a ribbonous core by feeding at least thirty reinforcing strands of glass fiber through said die while supplying said polymer to said die;
wherein said core with said coating thereon has a tensile break strength of at least 250 pounds; and
wherein said width of said core is approximately ⅝ inch.

18. The tape measure of claim 1 wherein said width of said tape is at least ⅝ inch.

19. The tape measure of claim 1 wherein said width of said tape is substantially closer to ⅝ inch than ½ inch.

20. The method of claim 11 wherein said width of said core is substantially closer to ⅝ inch than ½ inch.
